(19) United States
(12) Patent Application Publication
(10) Pub. No.: US 2014/0303842 A1
(43) Pub. Date: Oct. 9, 2014

(54) SYSTEM AND METHOD FOR MANAGING INCOMING MESSAGES IN A VEHICLE

(71) Applicants: Markus Andreas Boelter, Changshu (CN); Zi Yun, Changshu (CN); Yilin Liu, Changshu (CN); Linying Kuo, Changshu (CN); Leizhong Zhang, Changshu (CN)

(72) Inventors: Markus Andreas Boelter, Changshu (CN); Zi Yun, Changshu (CN); Yilin Liu, Changshu (CN); Linying Kuo, Changshu (CN); Leizhong Zhang, Changshu (CN)

(73) Assignee: QOROS AUTOMOTIVE CO., LTD., Changshu, Jangsu (CN)

(21) Appl. No.: 14/342,372

(22) PCT Filed: Aug. 31, 2011
(86) PCT No.: PCT/CN2011/079216

§ 371 Date: Jun. 6, 2014

(51) Int. Cl. B60W 50/00

(52) U.S. Cl. CPC B60W 50/0098
USPC 701/36

(57) ABSTRACT

The present inventive concepts relate to a system and a method for managing incoming messages in a vehicle. The system may include a receiver unit configured to receive incoming messages, a detection unit configured to determine a driving situation of the vehicle and to generate a notification control signal in response to the determined driving situation, and a notification unit coupled to the receiver unit and the detection unit, the notification unit comprising a touch screen configured to notify a driver of a received message in one of a number of different formats in response to the notification control signal.

### FIELD OF THE INVENTIVE CONCEPTS

The present inventive concepts relate to a system and a method for managing incoming messages in a vehicle, such as a passenger car, bus, truck, a motor boat or a plane.

### BACKGROUND OF THE INVENTIVE CONCEPTS

Many vehicles nowadays are equipped with a large number of messaging functions that alert and inform a driver about incoming cellular phone calls, e-mail messages, infotainment options, navigation instructions, advertisements concerning nearby locations, etc. Additionally, the driver can be informed about internal and external driving conditions, such as vehicle status, weather, time, traffic hazards, etc. As a result, a flood of information may be provided to a driver in a totally uncoordinated way, irrespective of the current driving situation and the driver's cognitive load.

EP 1 330 377 B1 describes a method of response synthesis in a driver assistance system, including the steps of: generating a master condition list, the master condition list being a set of conditions representing the current discrete states of sensor data monitored within a vehicle; determining the existence of an operating situation based on the master condition list; estimating a driver cognitive load based upon the master condition list; and determining a response to the operating situation in view of the driver's cognitive load and the operating situation, wherein the response is selected based upon whether the estimation of driver cognitive load is below or exceeds a threshold value for a particular service and effecting the selected response. Vehicle operating data can comprise operator activity data, environment data, operator condition data, operator preference data, and driver action feedback data. For example, in case of an incoming telephone call, in response to the driver cognitive load and the operating situation, a call can be forwarded to the driver, the call can be forwarded to a voicemail, and call completion can be delayed or interrupted. While the system described in this European patent ameliorates somewhat the uncoordinated flood of information described above, it does not provide an efficient way of presenting selected responses to the driver.

EP 1 415 864 B1 describes a vehicle information and interaction management system for managing message delivery and access to vehicle features and functions based on a driving workload estimate. The concept is similar to the one of EP 1 330 377 1. This document also fails to disclose an efficient way of displaying selected responses to a driver.

EP 1 549 526 B1 describes an interface for managing information, the interface comprising a plurality of buttons having an information indicator associated therewith, each button and information indicator pair being associated with the source of information. By using the buttons, a driver can select whether information from an associated information source may be disseminated or not. It is up to the user to choose to receive particular types of information by selecting the respective buttons. This system requires considerable hardware and, further, can increase a driver's cognitive load as the driver needs to monitor and select from a number of buttons for obtaining information.

In motor vehicles, it is further known to use screens for displaying a “main function”, e.g. the map of a navigational system, and additionally displaying icons for invoking other functions wherein the screen and underlying functions can be controlled via buttons as well as via touch-screen controls. See, for example, DE 10 2006 018 672 A1.

Other examples of a human machine interaction system of a vehicle using a touch-screen can be found in DE 10 2005 007 642 A1; DE 10 2008 017 716 A1; and DE 10 2009 033 061 A1, for example.

What is needed is a system and a method for managing incoming messages in a vehicle that can minimize distractions to a driver, in particular, when critical driving situations occur.

### SUMMARY OF THE INVENTIVE CONCEPTS

This object is met by a system for managing incoming messages in a vehicle as disclosed and described in the present application and according to the claimed inventive concepts. Various preferred embodiments are described below.

The principles of the present inventive concepts provide a system for efficiently managing incoming messages in a vehicle, the system including a receiver unit configured for receiving incoming messages, a detection unit configured for determining a driving situation of the vehicle and generating a notification control signal in response to the determined driving situation, and a notification unit coupled to the receiver unit and detection unit, the notification unit comprising a touch-screen configured to notify a driver of a received message in one of a number of different formats in response to the notification control signal. The system of the present inventive concepts is able to manage incoming messages, such as telephone calls, text messages, e-mails, as well as infotainment messages, advertisement, etc. Depending on the current driving situation, including the present demands requiring the driver's attention to be focused on operating the vehicle, the present inventive concepts can be used to notify the driver of an incoming message in one of a number of different ways. A touch-screen may be used to notify the driver, and can be configured to represent the incoming message in any of multiple different formats. Additionally, when the current driving situation requires the driver's focus to remain primarily on operating the vehicle and it is undesirable to draw the driver's attention away from driving to the message, an incoming message can be suppressed or delayed and the driver can be notified at a later point in time when driving conditions require less of the driver's attention.

In one embodiment, the detection unit is configured for classifying a driving situation into one of a number of driving conditions, such as a critical driving condition and a noncritical driving condition. The detection unit can use a number of sensors for detecting one or more vehicle operating data, environment data, driver activity data, and/or vehicle passenger activity data. More specifically, and by way of example, the detection unit can gather data from sensors which are normally provided in vehicles or which are specifically dedicated for the present inventive concepts, such as sensors for detecting the vehicle speed and vehicle acceleration, slip, throttle operation, break operation, steering wheel movements and the like. Additionally, environmental conditions, such as temperature, light conditions, humidity, road conditions, traffic conditions, lane following, headway traffic and the like can be taken into account. The detection unit can also determine a driving situation, at least in part, as a function of a driver's physical condition, such as fatigue or intoxication, or as a function of activities of other vehicle passengers, such as sound and movement within the vehicle cabin. All or a selected combination of this data can be processed in the detection unit in order to determine a driving situation and generate a notification control signal.

The driving situation may be classified into one of at least two different driving conditions, such as a critical driving condition and a noncritical driving condition. The driving situation can be classified into more detailed additional driving conditions, such as different levels of critical conditions, such as “higher attention required”, “collision threatening”, “collision unavoidable”, etc. A particular driving situation could be determined, for example, by defining a number of sensor data to be checked as well as individual sensor data thresholds associated with defined driving conditions. Classifying a driving situation as one of a number of defined driving conditions can be implemented, for example, by the use of a look-up table, by a decision tree, by an appropriate algorithm, by an object-based inference engine or by a rule-based decision engine.

The notification control signal may have at least two possible states, such as a notification enable state and a notification disable state. More detailed notification states can be provided for, however, such as enabling only defined prioritized messages, enabling only defined types of messages (e.g., forwarding phone calls but not forwarding e-mails and text messages), enabling only receipt of certain messages but not response thereto, enabling the notification of messages only when a driver having a certain proficiency level is registered, and any combination thereof.

The present inventive concepts also allows prioritization of incoming messages. For example, a driver can designate predetermined callers so that their messages have a higher priority than non-designated callers. A user can also give priority to certain types of messages, such as giving text messages a higher priority than phone calls, for example.

In order to provide a convenient human machine interface which causes minimum distraction to the driver's attention, in particular during critical driving situations, the system of the present inventive concepts may use a touch-screen which provides different formats for notifying a driver in response to the notification control signal. The different formats can comprise, for example, a message accept/reject screen, a message blocked screen, and a message summary screen. The message accept/reject screen can have different formats such as the display of an incoming call and touch-screen “buttons” for accepting or rejecting the call and/or the display of an incoming call together with a touch-screen button for rejecting a call and automatically sending a reply to the caller. In one of the formats, the touch-screen may be configured in such a way that one half of the screen is configured to accept the call and the other half of the screen is configured to reject the call. In another embodiment, the touch-screen can be configured to distinguish between swiping directions performed anywhere on the surface of the screen. Preferably, the whole or substantially the whole screen can be used for a swiping/touching action so that a driver does not need to locate individual touch-screen buttons to be activated. For example, it is possible to reserve only a border region of the screen surface for other input and/or display functions and dedicate the central area of the screen for display and control of messaging functions.

It is also possible to simply notify the driver of an incoming message without a driver having the option to accept the message, for instance, if the current driving situation does not allow any additional distraction of the driver at that time.

Moreover, in the system of the present inventive concepts, the touch-screen can also display a message summary screen for informing a driver about any missed and/or accepted calls and other messages received.

The present inventive concepts also provide a method for managing incoming messages, along the lines discussed above. The method can be implemented in software or firmware to run in a messaging control unit of a vehicle. The program can also be stored on a computer-readable medium for execution by a control device of a vehicle.

### SHORT DESCRIPTION OF DRAWINGS

The inventive concepts will now be described with reference to the attached drawings, wherein:

FIG. 1 is a schematic block diagram illustrating a system for managing incoming messages according to an embodiment of the inventive concepts,

FIG. 2 is a schematic block diagram of a notification unit of the system shown in FIG. 1;

FIG. 3 is a somewhat schematic view showing an example embodiment of a message accept/reject screen of a system for managing incoming messages according to the inventive concepts; and

FIG. 4 is a somewhat schematic view showing an example embodiment of a message summary screen of a system according to the inventive concepts.

### DETAILED DESCRIPTION OF EMBODIMENTS

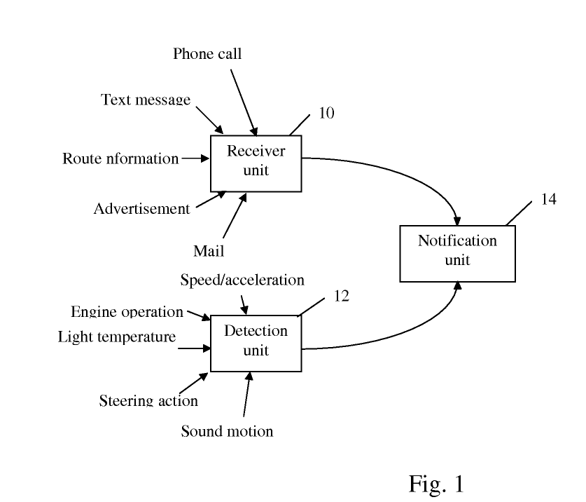

FIG. 1 shows a schematic block diagram of a system for managing incoming messages according to an embodiment of the inventive concepts. The system may comprise a receiver unit 10, a detection unit 12, and a notification unit 14. Outputs of the receiver unit 10 and the detection unit 12 may be forwarded to the notification unit 14. The system is preferably permanently installed in a vehicle, although it could be implemented as a carry-on system and could be integrated, for example, in a mobile communication device such as a smartphone.

The receiver unit 10 is preferably configured to receive a number of different types of messages, such as phone calls, text messages, e-mails, route information (e.g., location or direction data), advertisements, infotainment (such as music or video clips), etc. Rather than notifying a driver of an incoming message each time the message arrives, the present inventive concepts first determines a current driving situation and then decides whether, when, and how to notify the driver.

For determining the driving situation, the detection unit may be configured to detect a number of different driving parameters making use of sensors normally installed in a car and/or of specially dedicated sensors and detectors. The detection unit may, for example, be configured to detect the speed and acceleration of the vehicle as well as different engine operation parameters, such as actuation of throttle, engine temperature, oil pressure, etc. The detection unit 12 further may be configured to detect current driving behaviour and conditions such as steering action, lane following, headway traffic, etc. Furthermore, the detection unit 12 may be configured to detect environmental parameters such as temperature, light conditions, humidity, road conditions, etc. The detection unit 12 can further be configured to detect driver and passenger-related parameters, such as sound and motion within a vehicle cabin, fatigue or intoxication of a driver, etc.

According to the inventive concepts, all or part of these parameters may be processed to determine whether there a critical driving situation exists and derive and produce an appropriate notification control signal based on the driving situation. As explained above, by way of example, the driving situation can be determined using a look-up table, algorithms, and/or object-based or rule-based inference engines. The driving situation can be classified as one of at least two driving conditions, but can also be classified more finely to generate a notification control signal having one of multiple different levels for making a qualified decision regarding notifying a driver of selected messages at an appropriate selected time or times.

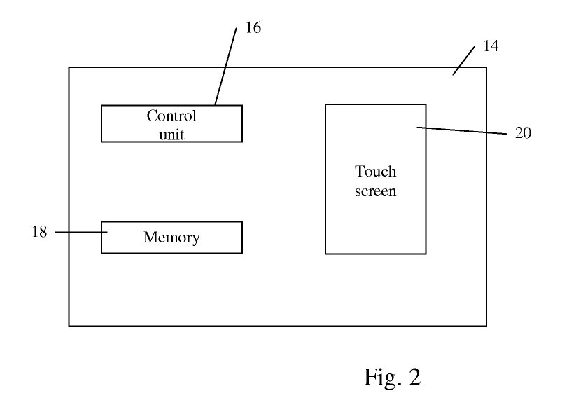

The message received by the receiver unit 10 and the notification control signal determined by the detection unit 12 are forwarded to the notification unit 14 which is shown, in somewhat further detail, in FIG. 2. The notification unit 14, in the example shown in FIG. 2, comprises a control unit 16, a memory 18, and a touch-screen 20. The control unit 16 and the memory 18 cooperate to determine which type of message shall be displayed, when the message is to be displayed, and in which format the message is displayed to a driver, as a function of the notification control signal. The memory 18 can include, for example, a look-up table for associating different driving conditions (driving control signals) with different types of messages and for determining an associated display format. Additionally, a driver can set certain priorities within the notification unit so that particular types of messages or messages from designated senders are treated differently from other messages. For example, incoming messages from pre-determined callers can have a higher priority and hence a driver can be notified of such messages in spite of a critical driving situation, i.e., in spite of a driving control signal which would normally suppress or delay notification of messages.

In one embodiment of the inventive concepts, the notification device will simply delay notifying a driver of any incoming message when a critical driving situation occurs and for as long as the critical driving situation persists. After the critical driving situation has passed, the notification unit may notify the driver of any messages that came in during the critical situation. In addition, if a driver has set certain priorities within the notification device, the driver can still be informed of incoming messages that meet the predetermined criteria (e.g., messages from predetermined callers), even during a critical driving situation. Alternatively, if driving conditions are divided into more detailed classifications, different situation levels can be configured to cause messages to be treated differently. For example, at a “most critical” driving condition, any incoming messages can be blocked while at a less critical, but still dangerous driving situation, only prioritized messages will be forwarded and, at a normal driving situation, all messages will be forwarded as soon as they are received. The inventive concepts, of course, are not limited to the specific message qualification and delivery embodiments described herein. After a critical situation has passed, a summarized notification page can be displayed on the touch-screen of the system to inform a driver of those messages which came in during the critical situation.

According to the inventive concepts, incoming messages may be displayed on a touch-screen in different formats, for example, as a function of the notification control signal and optionally as a function of priorities set by a driver. The touch-screen provides a human machine interaction interface which permits notification to a driver in a least distracting manner and, additionally, allows the driver to respond to messages, where necessary, again without requiring too much attention from the driver.

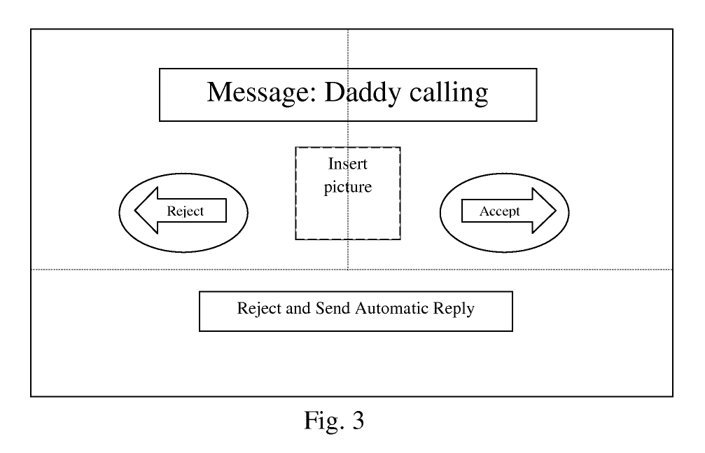

FIG. 3 shows an example of a screen configuration for notifying a driver of an incoming call during a driving situation which has been determined to be at an intermediate level, so that a driver will be notified of prioritized messages only. While, in the case of a highly critical driving situation or when a non-prioritized message is coming in, notification might simply be delayed, the screen configuration of FIG. 3 preferably is used for notifying a driver of prioritized messages arriving during less dangerous but still somewhat critical driving situations.

In the embodiment shown in FIG. 3, the driver may be notified of an incoming call and may further be offered the option to accept the call, reject the call, or reject the call and, at the same time, send an automatic reply to the caller, such as “I am driving now. I will call you later.” While the FIG. 3 display shows touch-screen buttons for selecting any one of these options, in a preferred embodiment of the inventive concepts, the screen effectively can be configured so that the entire screen, or almost the whole screen, is responsive to finger touch selection.

For example, the screen could be configured by defining three areas, as indicated by dashed lines in FIG. 3, corresponding to the different options. For example, a sweep or tap in the upper left third of the screen would reject the call, a sweep or tap in the upper right third of the screen would accept the call, and a sweep or tap in the bottom third of the screen would reject the call and send the automatic reply. This is made possible by dedicating defined fractions of the touch-screen, such as quarters or thirds, to the input of predefined control signals.

In another embodiment, the screen can be configured in such a way that, anywhere within the screen, a left sweep will reject the call, a right sweep will accept the call, and a tap on the screen will reject the call and send an automatic reply. Alternatively, therefore, defined finger movements, such as right and left sweep, one-finger tap or two-finger tap, anywhere within the screen surface can be associated with certain input control signals. More generally put, the screen may be configured such that an intuitive finger gesture allows a driver to interact with the notification unit without the driver having even to look at the screen, and hence without requiring much attention from the driver. A border region of the screen surface, e.g. about 2%, 5% or 10% of the screen surface, can be reserved for displaying and controlling other functions not related to notification of the driver.

This screen configuration format may be different from one when an incoming message is received during a normal driving situation. Further, when a notification is blocked, the display can be configured to show an indication that requires minimal attention from the driver, such as a badge to indicate an incoming message, with no option to retrieve the message.

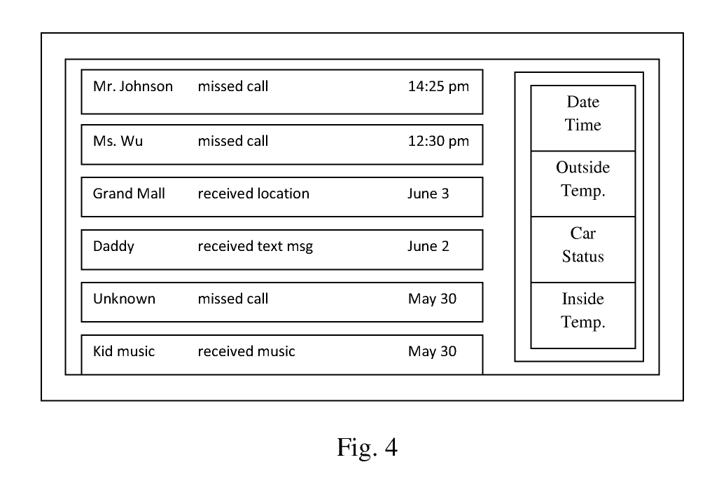

FIG. 4 shows another example of a screen configuration or format, used for informing a driver of incoming messages after the critical driving situation has passed. In the example of FIG. 4, the display format may be a message summary page, including a centralized layer that contains all notifications and allows a user to manage them. For example, the summarized notification page may include any missed calls, unread notifications of other types, and messages of other types not previously notified. The summarized notification page preferably also includes an option for the user to select, view, delete, and/or respond to individual messages and/or calls. Additionally, the summary notification page can display other information which might be interesting to a driver such as date and time, outside weather conditions, cabin temperature, and/or additional car status data.

Further, this or another screen configuration can comprise input options for a driver to set or select a particular driver profile so that a notification control signal, as well as optional priorities, can be adapted to an individual driver's preferences and needs. According to the inventive concepts, it is possible to combine the notification control signal with a driver proficiency level to take into account, for example, a driver's experience level, recognizing that an inexperienced driver can handle fewer distractions when operating the vehicle than a more experienced driver. Accordingly, it is within the scope of the inventive principles to configure the notification unit 14 in such a way that it determines when and how to notify a driver also as a function of individual driver parameters, such as a driver proficiency level.

The interactive system according to the present inventive concepts is capable of managing incoming messages in response to driving conditions and driver's needs in a user-friendly and minimally distractive manner. The notification unit may avoid sending incoming messages in particular critical driving situations or may be configured to send the incoming message based on preset priorities in a less distractive manner. Further, as a larger area of the touch-screen can be configured to be responsive to acceptance and rejection gestures, a driver can select a desired function easily and accurately without looking at the screen, taking less time away from paying attention to the road. In this way, the incoming message is less distractive to the driver while still meeting the needs of the driver.

1. A system for managing incoming messages in a vehicle, the system including:
a receiver unit configured for receiving incoming messages,
a detection unit configured to determine a driving situation of the vehicle and generate a notification control signal in response to the determined driving situation, and
a notification unit coupled to the receiver unit and the detection unit, the notification unit comprising a touch screen configured to notify a driver of a received message in one of a number of different formats for notifying a driver based on the notification control signal.

2. The system of claim 1 wherein the detection unit is configured to classify a determined driving situation into one of at least two driving conditions, including a critical driving condition and a noncritical driving condition.

3. The system of claim 2 wherein the detection unit is configured to generate the notification control signal, said notification control signal having one of at least two states, including a notification enable state and a notification disable state.

4. The system of claim 1, wherein the notification unit is configured to delay driver notification in response to the notification control signal.

5. The system of claim 1, wherein the notification unit is configured to prioritize incoming messages for notifying a driver of a received message in response to the notification control signal and a message priority.

6. The system of claim 5, wherein said formats for notifying the driver comprise a message accept/reject screen, a message blocked screen, and a message summary screen.

7. The system of claims 6, wherein the notification unit is configured to display said message accept/reject screen in one of a number of different formats in response to the notification control signal and the message priority.

8. The system of claim 1, wherein, in one of said formats, the touch screen is configured to receive a user input anywhere on the surface of the touch screen.

9. The system of claim 8, wherein, in said one format, the touch screen is configured to differentiate user inputs as at least one of a sweep from left to right, a sweep from right to left, and a tap anywhere on the surface of the screen.

10. The system of claim 8, wherein the touch screen is configured to differentiate user inputs in different-ones of predefined fractions of the screen greater than or equal to approximately one-quarter of the screen surface.

11. The system of claim 1, wherein the detection unit comprises at least one sensor for detecting at least one of vehicle operating data, environment data, driver activity data, and vehicle passenger activity data.

12. A method for managing incoming messages in a vehicle, the method comprising:
receiving an incoming message in the vehicle,
determining a driving situation of the vehicle and generating a notification control signal based on the determined driving situation, and
notifying a driver of a received message on a touch screen in one of a number of different formats in response to the notification control signal.

13. The method of claim 12, further comprising classifying a determined driving situation into one of at least two driving conditions, including a critical driving condition and a noncritical driving condition.

14. The method of claim 12, further comprising generating the notification control signal having one of at least two states, including a notification enable state and a notification disable state.

15. The method of claim 12 wherein driver notification delayed in response to the notification control signal.

16. The method of claim 12, further comprising prioritizing incoming messages and notifying a driver of a received message in one of a number of different formats in response to the notification control signal and a message priority.

17. The method of claim 12, wherein one of a message accept/reject screen, a message blocked screen, and a message summary screen is displayed when an incoming message has been received.

18. The method of claim 16, wherein, in response to the notification control signal and the message priority, said message accept/reject screen is displayed in a selected one of at least two different formats, and a user inputs a control signal by swiping or tapping on the touch screen anywhere on the surface of the touch screen.

19. The method of claim 12, wherein determining a driving situation comprises detecting at least one of vehicle operating data, environment data, driver activity data, and vehicle passenger activity data.

20-23. (canceled)

24. A computer-readable medium containing instructions that, when executed by a control device of a vehicle, cause the control device to perform the method of claim 12.
